(19) United States
(12) Patent Application Publication
(10) Pub. No.: US 2011/0228558 A1
(43) Pub. Date: Sep. 22, 2011

(54) PLANAR LIGHT SOURCE DEVICE

(75) Inventors: Tatsuo Uchida, Miyagi (JP); Yoshito Suzuki, Miyagi (JP); Tohru Kawakami, Miyagi (JP); Takahiro Ishinabe, Miyagi (JP); Baku Katagiri, Miyagi (JP); Yoshihiro Hashimoto, Osaka (JP); Shoichi Ishihara, Osaka (JP); Shuichi Kozaki, Osaka (JP); Yutaka Ishii, Osaka (JP)

(73) Assignees: SHARP KABUSHIKI KAISHA, Osaka-shi, Osaka (JP); TOHOKU UNIVERSITY, Sendai-shi, Miyagi (JP)

(21) Appl. No.: 13/130,758

(22) PCT Filed: Oct. 13, 2009
(86) PCT No.: PCT/JP2009/067735

§ 371 Date: Jun. 2, 2011

(30) Foreign Application Priority Data
Nov. 27, 2008 (JP) 2008-302925

(51) Int. Cl. F21V 7/22

(52) U.S. Cl. 362/607

(57) ABSTRACT

Conventional planar light source devices have a problem that increasing a utilization ratio of light results in a very narrow angle distribution of light. A planar light source device of the present invention has a light source (1), a light guide plate (2) for introducing light coming from the light source via a light-incident plane of the light guide plate and emits the light from almost all area of a light emission plane, and a light source side reflector (3) for reflecting the light coming from the light source and light which comes from the light source and is reflected by the light-incident plane of the light guide plate so that the reflected light is emitted to the light-incident plane of the light guide plate. The planar light source device further includes a lower side reflector (5) for introducing light emitted from the lower plane of the light guide plate into the light guide plate again, and an optical member (4) for changing a traveling direction of first light (10) which is introduced via the light-incident plane to pass through the light guide plate and is emitted from an upper plane of the light guide plate to a vertical upper direction. The lower side reflector is inclined by an angle of 5°-60° with respect to the lower plane of the light guide plate, and θ₂=90°−θ₁±10° is met where θ₁ (°) represents a maximum angle between the upper plane and a direction in which the first light is emitted from the upper plane and θ₂ (°) represents an apex angle of the optical member.

### TECHNICAL FIELD

The present invention relates to a planar light source device. To be more specific, the present invention relates to a planar light source device applied to a backlight etc. of a transmission LCD (Liquid Crystal Display) and a semi-transmission LCD.

### BACKGROUND ART

Known examples of planar light source devices intended for increasing a utilization ratio of light from a light source are as follows.

Patent Literature 1 describes a light source device using a sidelight-type backlight guide plate. One side of the sidelight-type backlight guide plate is provided with a layer whose transmittance varies depending on the angle of light, and which transmits vertically incident light but reflects obliquely incident light. The other side of the sidelight-type backlight guide plate is provided with a reflecting plate having a repeated slant structure. This structure is intended for reducing absorption loss of light due to repeated reflection etc.

Further, Patent Literature 2 describes a liquid crystal display device including a second transparent substrate doubling as a light guide plate, a first low refractive index layer provided on the second transparent substrate so as to be closer to a liquid crystal layer, and a second low refractive index layer provided on the second transparent substrate so as to be farer from the liquid crystal layer, wherein an inequality of n1<n2<n0 is met, where n0 indicates a refractive index of the second transparent substrate and n1 and n2 indicate refractive indices of the first low refractive index layer and the second low refractive index layer, respectively. This liquid crystal display device is intended for increasing a utilization ratio of light from a light source by preventing the light which comes from the light source and is introduced into the transparent substrate from being directly emitted toward the liquid crystal layer via the first low refractive index layer and causing most of the light to be emitted toward a polarizing plate via the second low refractive index layer.

### CITATION LIST

### Patent Literatures

### [Patent Literature 1]

Japanese Patent Application Publication, Tokukai No. 2005-79008 (published on Mar. 24, 2005)

### [Patent Literature 2]

Japanese Patent Application Publication, Tokukai No. 2007-47303 (published on Feb. 22, 2007)

### SUMMARY OF INVENTION

### Technical Problem

The planar light source device described in Patent Literature 1 requires a layer whose transmittance varies depending on the angle of light, and which transmits vertically incident light but reflects obliquely incident light. However, if reflectance of light obliquely incident to such a layer is low, the layer transmits the light, which becomes stray light and causes deterioration in an angle characteristic (e.g. causes variation in light emitted to a liquid crystal panel). Accordingly, it is deemed to be very difficult to properly realize an angle characteristic (e.g. distribution of light emitted to the liquid crystal panel) of such a layer. Further, light reflected by such a layer is reflected by the reflecting plate having a repeated slant structure in a vertical direction and is emitted to the liquid crystal panel. Some amount of light is emitted from the light guide plate to the reflecting plate directly, and such light is also reflected by the reflecting plate in a vertical direction and is emitted to the liquid crystal panel. Consequently, angle distribution of light coming from the planar light source device (to be more specific, distribution of angle indicating traveling direction of light) is very narrow.

In the planar light source described in Patent Literature 2, light emitted from the lower plane of the portion serving as the light guide plate is reflected by a slant reflecting plate in a vertical direction and is emitted to the liquid crystal panel. Since two layers with different refractive indices are provided on upper and lower planes, respectively, of the portion serving as the light guide plate, the light reflected by the reflecting plate in a vertical direction passes through many interfaces, which causes several percentage of interface reflection and drops transmittance. Further, although Patent Literature 2 describes that light is not emitted from the upper plane of the portion serving as the light guide plate, light is in fact emitted also from the upper plane and is directly incident to the liquid crystal layer. The light being incident in this manner has not passed through a polarizer and so greatly drops display quality. That is, in the planar light source device described in Patent Literature 2, among light arriving at the liquid crystal panel, only light traveling in a vertical direction is normal, resulting in a narrow viewing angle. Further, since unpolarized light is incident to the liquid crystal panel, oblique viewing angle suffers low display quality.

As described above, the conventional planar light source devices suffer a problem that increasing a utilization ratio of light results in very narrow angle distribution of light.

The present invention was made in view of the foregoing problem. An object of the present invention is to provide a planar light source device in which light can be efficiently emitted from an upper plane of a light guide plate and the emitted light has a proper angle distribution centering an outward normal to the upper plane of the light guide plate.

### Solution to Problem

In order to solve the foregoing problem, the inventors of the present invention have studied how to emit light efficiently from the upper plane of a light guide plate in such a manner that the emitted light has a certain degree of angle distribution. As a result, the inventors have completed the following invention.

A planar light source device of the present invention includes: a light source; a light guide plate including a light-incident plane via which light emitted from the light source is introduced into the light guide plate, and an upper plane and a lower plane serving as a pair of light emitting planes via which the introduced light is emitted from the light guide plate; and a light source side reflector for reflecting light which is emitted from the light source and is not directly introduced into the light guide plate via the light-incident plane in such a manner that the reflected light is directed toward the light-incident plane, the planar light source device further including: a reflecting member, positioned to face the lower plane of the light guide plate, for reflecting light emitted from the lower plane of the light guide plate in such a manner that the reflected light is introduced into the light guide plate again; and an optical member, positioned to face the upper plane of the light guide plate, for changing a traveling direction of light emitted from the upper plane of the light guide plate to a direction forming an angle of 10° or less with respect to an outward normal to the upper plane of the light guide plate, a plurality of reflectors being positioned on the reflecting member, each of the plurality of reflectors standing at a position close to the light source in such a manner that an angle between each of the plurality of reflectors and the lower plane of the light guide plate is 5°-60°, and the optical member being positioned in such a manner that an apex thereof faces the upper plane of the light guide plate and an equation (1) below is satisfied

θ₂=90°−θ₁±10° (1)

where θ₁ (°) represents a maximum angle between the upper plane and a direction in which the light is emitted from the upper plane and θ₂ (°) represents an angle of the apex.

With the arrangement, the planar light source device includes an optical member, positioned to face the upper plane of the light guide plate, for changing a traveling direction of light emitted from the upper plane of the light guide plate to a direction forming an angle of 10° or less with respect to an outward normal to the upper plane of the light guide plate, the optical member is positioned in such a manner that an apex thereof faces the upper plane of the light guide plate, and the equation (1) is met where θ₁ (°) represents a maximum angle between the upper plane and a direction in which the light is emitted from the upper plane and θ₂ (°) represents an angle of the apex. Consequently, the light which is emitted from the upper plane, is incident to the optical member, and is wholly reflected in the optical member is emitted from the upper plane of the optical member with an angle of ±10° or less with respect to a vertical upper direction. This enables effectively reducing stray light.

Further, with the arrangement, the planar light source device includes a reflecting member, positioned to face the lower plane of the light guide plate, for reflecting light emitted from the lower plane of the light guide plate in such a manner that the reflected light is introduced into the light guide plate again, and a plurality of reflectors is positioned on the reflecting member and each of the plurality of reflectors stands at a position close to the light source in such a manner that an angle between each of the plurality of reflectors and the lower plane of the light guide plate is 5°-60°. Consequently, when the light emitted from the lower plane is reflected by the reflecting member in a substantially vertical upper direction, passes through the light guide plate while hardly changing its traveling direction, and is incident to the optical member, the traveling direction of the light can be changed in a direction different from the substantially vertical upper direction.

Consequently, the planar light source device of the present invention enables obtaining light efficiently from the upper plane of the light guide plate in such a manner that the obtained light has a certain degree of angle distribution centering an angle corresponding to a vertical upper direction.

A planar light source device of the present invention includes: at least one light source; a light guide plate designed such that at least one end in a plate-length direction is a light-incident plane of the light guide plate, one of two ends in a plate-thickness direction is an upper plane of the light guide plate, the other is a lower plane of the light guide plate, the upper plane and the lower plane serve as light emitting planes, an outward normal to the upper plane of the light guide plate is a vertical upper direction, and light emitted from the light source is introduced into the light guide plate via the light-incident plane and is emitted from almost all areas of the light emitting planes; and a light source side reflector for reflecting light emitted from the light source and light which is emitted from the light source and is reflected by the light-incident plane in such a manner that the light reflected by the light source side reflector is directed toward the light-incident plane, the planar light source device further comprising: a lower side reflector for reflecting light emitted from the lower plane of the light guide plate in such a manner that the reflected light is incident into the light guide plate again; and an optical member for changing a traveling direction of first light to a substantially vertical upper direction, the first light being light which is introduced into the light guide plate via the light-incident plane, passes through the light guide plate, and is emitted from the upper plane of the light guide plate, the lower side reflector being positioned to face the lower plane of the light guide plate, a plurality of small reflecting planes being positioned on the lower side reflector, and each of the plurality of small reflecting planes being inclined by an angle of 5°-60° with respect to the lower plane of the light guide plate in such a manner that a portion of each of the plurality of small reflecting planes which portion is farer from the light-incident plane of the light guide plate is closer to the lower plane of the light guide plate, the optical member having an apex facing the upper plane of the light guide plate, and

an equation (1) below being satisfied

θ₂=90°−θ₁±10° (1)

where θ₁ (°) represents a maximum angle between the upper plane and a direction in which the first light is emitted from the upper plane and θ₂ (°) represents an angle of the apex.

With the arrangement, the planar light source device includes an optical member for changing a traveling direction of first light to a substantially vertical upper direction, the first light being light which is introduced into the light guide plate via the light-incident plane, passes through the light guide plate, and is emitted from the upper plane of the light guide plate, and the equation (1) is met where θ₁ (°) represents a maximum angle between the upper plane and a direction in which the first light is emitted from the upper plane and θ₂ (°) represents an angle of the apex. Consequently, the first light which is incident to the optical member and is wholly reflected in the optical member is emitted from the upper plane of the optical member with an angle of ±10° or less with respect to a vertical upper direction. This enables effectively reducing stray light.

Further, with the arrangement, the planar light source device includes a lower side reflector for reflecting light emitted from the lower plane of the light guide plate in such a manner that the reflected light is incident into the light guide plate again, the lower side reflector is positioned to face the lower plane of the light guide plate, a plurality of small reflecting planes is positioned on the lower side reflector, and each of the plurality of small reflecting planes is inclined by an angle of 5°-60° with respect to the lower plane of the light guide plate in such a manner that a portion of each of the plurality of small reflecting planes which portion is farer from the light-incident plane of the light guide plate is closer to the lower plane of the light guide plate. Consequently, when the light emitted from the lower plane is reflected by the lower side reflector in a substantially vertical upper direction, passes through the light guide plate while hardly changing its traveling direction, and is incident to the optical member, the traveling direction of the light can be changed in a direction different from the substantially vertical upper direction.

Consequently, the planar light source device of the present invention enables obtaining light efficiently from the upper plane of the light guide plate in such a manner that the obtained light has a certain degree of angle distribution centering an angle corresponding to a vertical upper direction.

In the planar light source device of the present invention, the optical member changes a traveling direction of second light to a direction inclined by more than 0° and not more than 60° with respect to a vertical upper direction, the second light being light which is introduced into the light guide plate via the light-incident plane, passes through the light guide plate, is emitted from the lower plane of the light guide plate, is reflected by the lower side reflector, is introduced into the light guide plate again via the lower plane of the light guide plate, passes through the light guide plate, and is emitted from the upper plane of the light guide plate.

Consequently, the planar light source device of the present invention enables the obtained light to have angle distribution of ±60° centering an angle corresponding to a vertical upper direction.

In the planar light source device of the present invention, the lower side reflector is inclined by 20°-50° with respect to the lower plane of the light guide plane.

Consequently, the planar light source device of the present invention enables further increasing a utilization ratio of light.

In the planar light source device of the present invention, the optical member is a prism sheet.

Consequently, the planar light source device of the present invention enables more efficiently changing a traveling direction of light, more efficiently obtaining light from the upper plane of the light guide plate in such a manner that the obtained light is more easily have a certain degree of angle distribution centering an angle corresponding to a vertical upper direction.

In the planar light source device of the present invention, the prism sheet is designed such that a width of each prism is 300 μm or less and an area of a plane of the prism sheet which plane faces the upper plane of the light guide plate is equal to or larger than an area of the upper plane of the light guide plate.

Consequently, the planar light source device of the present invention enables making spatial unevenness in luminance less visible, and reducing light which is emitted from the upper plane of the light guide plate but is not incident to the prism sheet, thereby increasing a utilization ratio of light.

The planar light source device of the present invention further includes a reflection preventing film on the lower plane of the light guide plate.

Consequently, the planar light source device of the present invention enables reducing wasteful light reflected by the lower plane of the light guide plate out of light emitted from the lower plane and is reflected by the lower side reflector, thereby further increasing a utilization ratio of light.

The planar light source device of the present invention further includes a reflection preventing film on the light-incident plane of the light guide plate.

Consequently, the planar light source device of the present invention enables reducing wasteful light reflected by the light-incident plane of the light guide plate and is absorbed by the light source out of light emitted from the light source, thereby further increasing a utilization ratio of light.

In the planar light source device of the present invention, the lower reflector is designed such that a width of each small reflecting plane is 300 μm or less and an area of a plane of the lower reflector which plane faces the lower plane of the light guide plate is equal to or larger than an area of the lower plane of the light guide plate.

Consequently, the planar light source device of the present invention enables making spatial unevenness in luminance less visible, and reducing light which is emitted from the lower plane of the light guide plate but is not incident to the lower side reflector, thereby increasing a utilization ratio of light.

### Advantageous Effects of Invention

The present invention enables efficiently obtaining light from the upper plane of the light guide plate of the planar light source device in such a manner that the obtained light has a certain degree of angle distribution centering an angle corresponding to a vertical upper direction.

That is, the planar light source device of the present invention enables efficiently obtaining light from the upper plane of the light guide plate in such a manner that the obtained light has an appropriate angle distribution centering an outward normal to the light guide plate.

### BRIEF DESCRIPTION OF DRAWINGS

FIG. 1 is a cross sectional drawing schematically showing an example of the present invention.

FIG. 2 is an explanatory drawing showing an operation of a lower side reflector in the present invention.

FIG. 3 is an explanatory drawing showing an operation of a prism sheet (optical member) in the present invention.

FIG. 4 is a cross sectional drawing schematically showing an example (different from the aforementioned example) of the present invention.

FIG. 5 is a cross sectional drawing schematically showing an example (different from the aforementioned examples) of the present invention.

FIG. 6 is a cross sectional drawing schematically showing an example (different from the aforementioned examples) of the present invention.

FIG. 7 is a graph showing a relation between an angle α formed by a lower side reflector and a lower plane of a light guide plate and relative intensity of light emitted from an upper plane of the light guide plate.

FIG. 8 is a cross sectional drawing schematically showing a prism sheet (optical member) in the present invention.

FIG. 9 is an explanatory drawing showing an angle at which second light is emitted in the present invention.

FIG. 10 is an explanatory drawing showing an angle at which first light is emitted in the present invention.

FIG. 11 is a cross sectional drawing schematically showing an example (different from the aforementioned examples) of the present invention.

### DESCRIPTION OF EMBODIMENTS

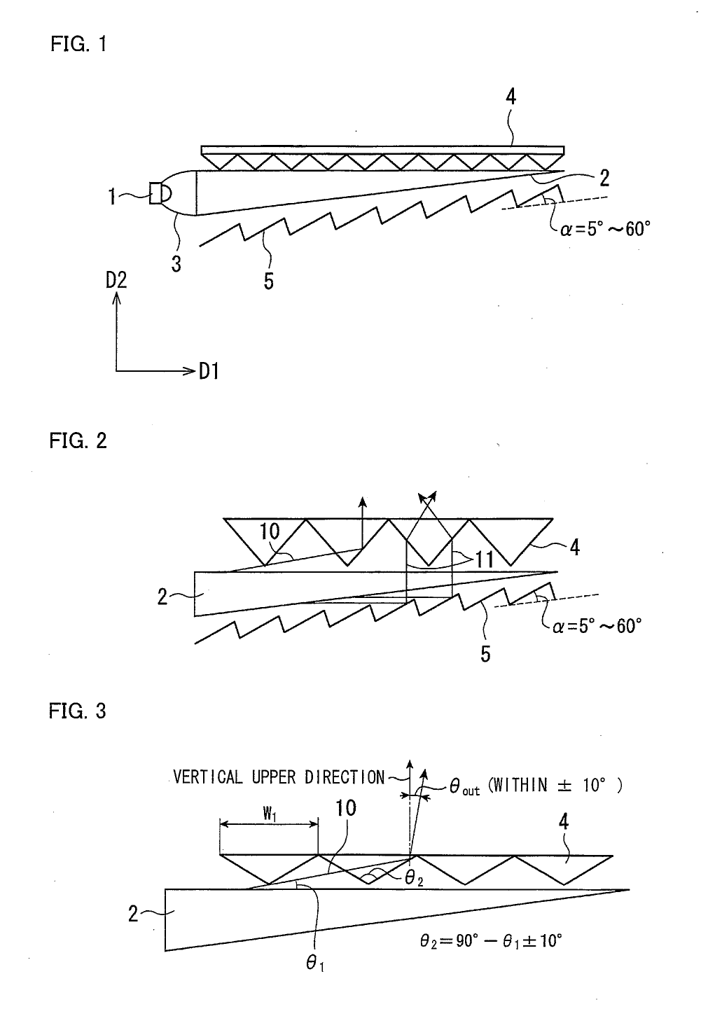

The following explains embodiments of the present invention with reference to FIGS. 1-11. The present invention is not limited to these embodiments.

FIG. 1 is a cross sectional drawing schematically showing an example of the present invention. As shown in FIG. 1, a planar light source device of the present invention mainly includes a light source 1, a light guide plate 2, a light source side reflector 3, a prism sheet (optical member) 4, and a lower side reflector (reflecting member) 5.

The light source 1 may be either a point light source or a planar light source. Preferable examples of the point light source include a white LED (Light Emitting Diode), an RGB-LED (Light Emitting Diode made by molding R, G, and B chips in one package), a multi-color LED, and a laser light source. A preferable example of the planar light source is an organic EL (Electro Luminescence) light source.

The light guide plate 2 is preferably a light guide plate whose cross section vertical to a plate-width direction (i.e. direction vertical to directions D1 and D2 in FIG. 1) has a wedge shape (wedge light guide plate). At least one end of the light guide plate 2 in a plate-length direction (direction D1 in FIG. 1) is a light-incident plane of the light guide plate (light-incident plane of the light guide plate 2), one end of the light guide plate in a plate-thickness direction (direction D2 in FIG. 1) (which one end is closer to the prism sheet 4) is an upper plane of the light guide plate (upper plane of the light guide plate 2), the other end of the light guide plate in the plate-thickness direction (which end is closer to lower side reflector 5) is a lower plane of the light guide plate (lower plane of the light guide plate 2), and these two ends are regarded as light-emitting planes. An outward normal to the upper plane of the light guide plate 2 is referred to as a vertical upper direction. A direction which forms an angle of ±10° or less with respect to the outward normal to the upper plane of the light guide plate 2 is referred to as a substantially vertical upper direction. The light guide plate 2 is designed and produced such that light (emitted) from the light source 1 is introduced into the light guide plate 2 via the light-incident plane of the light guide plate 2 and the light is emitted from substantially all areas of the light-emitting planes (e.g. 90% or more areas of the light-emitting planes). Such designing and production of the light guide plate 2 are easily made by a normal technique for designing and producing light guide plates, and therefore an explanation thereof is omitted here. The light-incident plane of the light guide plate 2 is positioned to face the light source 1 so that light (emitted) from the light source 1 is introduced into the light guide plate 2 via the light-incident plane.

The light source side reflector 3 reflects light emitted from the light source 1 and light emitted from the light source 1 and reflected by the light-incident plane of the light guide plate 2, so that the light reflected by the light source side reflector 3 is incident to the light-incident plane of the light guide plate 2. An example of the light source side reflector 3 is a housing (reflector) etc. which houses the light source 1 and the light-incident plane of the light guide plate 2 and whose internal surface is a reflecting plane. The housing (reflector) may be designed and produced according to a normal method.

The prism sheet 4 may be an optical member other than a prism sheet as long as the member changes a traveling path of light as explained below. Examples of the prism sheet used in the present invention include a (symmetrical) prism sheet shown in (a) of FIG. 8 and an asymmetrical prism sheet shown in (b) of FIG. 8. An advantage of the asymmetrical prism sheet is that the asymmetrical prism sheet enables converging more amount of first light upright above the upper plane of the light guide plate than the symmetrical prism, and enables increasing transmittance of light. However, when the asymmetrical prism sheet is used, second light transmitted by the asymmetrical prism has asymmetrical angle distribution due to the asymmetric property of the prism. A representative example of a commercially available asymmetrical prism sheet is a total reflection prism sheet (“DIAART” produced by MITSUBISHI RAYON CO., LTD.)

The lower side reflector (reflecting member) 5 causes light emitted from the lower plane of the light guide plate 2 to be introduced into the light guide plate 2 again. The lower side reflector 5 is made by positioning, for example, a plurality of small reflecting planes (a plurality of reflectors) on a plane facing the lower plane of the light guide plate 2. In the lower side reflector 5, each of the plurality of small reflecting planes is inclined in such a manner that a portion thereof farer from the light-incident plane of the light guide plate 2 is closer to the lower plane of the light guide plate 2, and the angle (referred to as a) of the inclination is 5°-60°. That is, the lower side reflector 5 is designed such that each of the plurality of small reflecting planes stands at a position close to the light source 1 in such a manner that each small reflecting plane and the lower plane of the light guide plate 2 forms an angle of 5°-60°. Consequently, the lower side reflector 5 can reflect the light from the lower plane of the light guide plate 2 so that almost all of the reflected light is introduced into the light guide plate 2 again.

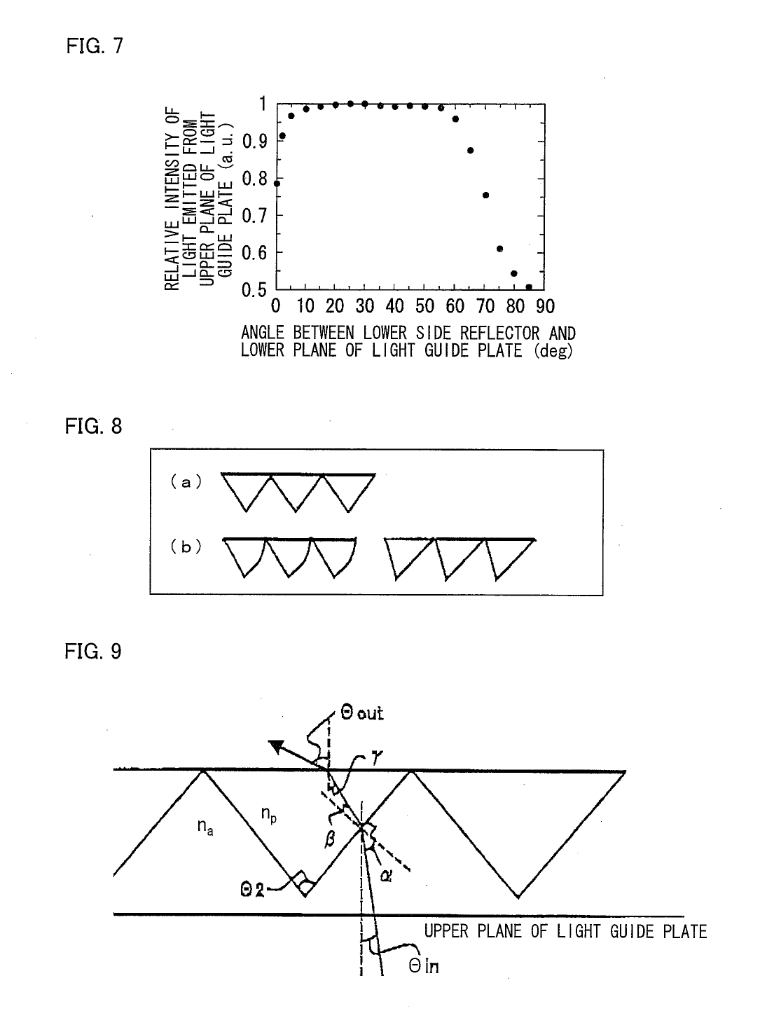

In this regard, an explanation is made below with reference to FIG. 7. FIG. 7 is a graph showing a relation between the angle α formed by the lower side reflector and the lower plane of the light guide plate and relative intensity of light emitted from the upper plane of the light guide plate. Specifically, FIG. 7 is a graph showing a relation between the angle α formed by the small reflecting plane of the lower side reflector 5 and a plane parallel to the lower plane of the light guide plate 2 (plane indicated by dotted line in FIG. 1) and relative intensity of light emitted from the upper plane of the light guide plate 2. This graph is obtained by calculating with an optical simulator the whole amount of luminous flux of light emitted from the upper plane of the light guide plate 2 when the angle α formed by the lower reflector 5 and the lower plane of the light guide plate 2 varies in the range of 0°-89.99° and sorting the results in order. According to FIG. 7, in a case where α is less than 5°, more amount of the reflected light from the lower side reflector 5 travels toward the outside at the thin edge of the wedge (i.e. a side opposite to the light-incident plane of the light guide plate), and such light is regarded as a loss. In a case where α is more than 60°, more amount of the reflected light from the lower side reflector 5 travels toward the outside at the bottom of the wedge (i.e. a side at the light-incident plane of the light guide plate), and such light is regarded as a loss. Either case results in undesirable reduction in a utilization ratio of light. Further, in either case, the light reflected by the lower side reflector 5 and is incident to the lower plane of the light guide plate 2 again has a very small incident angle with respect to the lower plane of the light guide plate 2 and consequently a ratio of light transmitted by the light guide plate 2 is reduced. This results in undesirable reduction in a utilization ratio of light incident to the light guide plate 2 again.

According to FIG. 7, when a is limited to a narrower range of 20°-50°, a utilization ratio of light is further increased. Accordingly, this range is preferable.

The prism sheet 4 changes the traveling direction of first light 10 which is incident to the light-incident plane of the light guide plate 2, passes through the light guide plate 2, and is emitted from the upper plane of the light guide plate 2, so that the first light 10 travels in a substantially vertical upper direction (direction which forms an angle of ±10° with respect to a vertical upper direction). The prism sheet 4 is obtained by disposing a plurality of prisms in series on one side of a sheet and positioning the sheet right above the upper plane of the light guide plate 2 so that the plane where the prisms are disposed faces the upper plane of the light guide plate 2.

An explanation is made as to the operation of the planar light source device of the present invention with reference to FIG. 2. For convenience of explanation, light 10 which enters the light guide plate 2 via the light-incident plane of the light guide plate 2, passes through the light guide plate 2, and is emitted from the upper plane of the light guide plate 2 is referred to as first light 10, and light 11 which enters the light guide plate 2 via the light-incident plane of the light guide plate 2, passes through the light guide plate 2, is emitted from the lower plane of the light guide plate 2, is reflected by the lower side reflector 5, is incident to the light guide plate 2 via the lower plane of the light guide plate 2 again, passes through the light guide plate 2, and is emitted from the upper plane of the light guide plate 2 is referred to as second light 11. The traveling direction of the first light 10 is changed by the prism sheet to be a substantially vertical upper direction. On the other hand, the second light 11 is emitted from the lower plane of the light guide plate, and then reflected by the lower side reflector 5 which forms an angle of 5°-60° with respect to the lower plane of the light guide plate, and the second light 11 passes through the light guide plate 2 while hardly changing its traveling direction, and is incident to the prism sheet 4 where the traveling direction of the second light 11 is changed to a direction different from its former substantially vertical upper direction.

Specifically, the planar light source device of the present invention changes the traveling direction of the second light 11 to a direction which forms an angle of more than 0° and not more than 60° with respect to a vertical upper direction. With reference to FIG. 9, the following details the angle at which the second light 11 is emitted.

In FIG. 9, nₐ represents a refractive index of air, nₚ represents a refractive index of a prism sheet, θᵢₙ represents an angle between a direction in which light reflected by the lower side reflector and emitted from the upper plane of the light guide plate (second light) is incident to the prism sheet and a vertical upper direction, θₒᵤₜ represents an angle between a direction in which the second light is emitted from the prism sheet and the vertical upper direction, α represents an angle between a direction normal to the light-incident plane of the prism sheet and the direction in which the second light is incident to the prism sheet, β represents an angle between the direction normal to the light-incident plane of the prism sheet and a direction in which the second light travels in the prism sheet, γ represents an angle between a direction normal to the light-emitting plane of the prism sheet (vertical upper direction) and the direction in which the second light is emitted from the prism sheet, and θ₂ represents an apex angle of the prism sheet.

Herein, θₒᵤₜ is obtained by an equation (2) below.

α=90°−θᵢₙ−(θ₂)/2

According to the Snell's law,

nₐ×sin(α)=nₚ×sin(β)

γ=90°−(θ₂)/2

According to the Snell's law,

nₐ×sin(θₒᵤₜ)=nₚ×sin(γ) (2)

For example, assume that the refractive index of air nₐ=1.0, the refractive index of the prism sheet nₚ=1.5, the apex angle of the prism sheet θ₂=90°, and the angle between a direction in which light reflected by the lower side reflector is emitted from the upper plane of the light guide plate and a vertical upper direction θᵢₙ=0°-20°. In this case, θₒᵤₜ=26°-46°.

Among the above conditions, when θ₂=60°-120°, θₒᵤₜ=16°-58°.

Since the angle of θᵢₙ depends on the angle between the lower side reflector and the lower plane of the light guide plate, θₒᵤₜ varies depending on the apex angle of the prism sheet θ₂ and the angle between the lower side reflector and the lower plane of the light guide plate.

In consideration of the actual design limit, it is possible to control angle distribution of the second light 11 to be within the range of ±20° or less to ±60° or less with respect to the vertical upper direction.

Accordingly, it is possible to obtain light from the planar light source device with a high utilization ratio and angle distribution of the obtained light is in a certain range, i.e. in a range of ±60° or less with respect to the vertical upper direction.

In the present invention, as shown in FIGS. 1-6, the prism sheet 4 is designed to have apexes facing the upper plane of the light guide plate 2, and each apex angle of the prism sheet 4 (to be more specific, the apex angle of each prism in the prism sheet 4) θ₂ (°) meets an equation (1) below.

θ₂=90°−θ₁±10° (1)

where θ₁ (°) represents the maximum angle between the upper plane of the light guide plate 2 and a direction in which the first light 10 is emitted from the upper plate of the light guide plate 2.

The equation (1) is equivalent to an equation (1A) below.

80°−θ₁≦θ₂≦100°−θ₁ (1A)

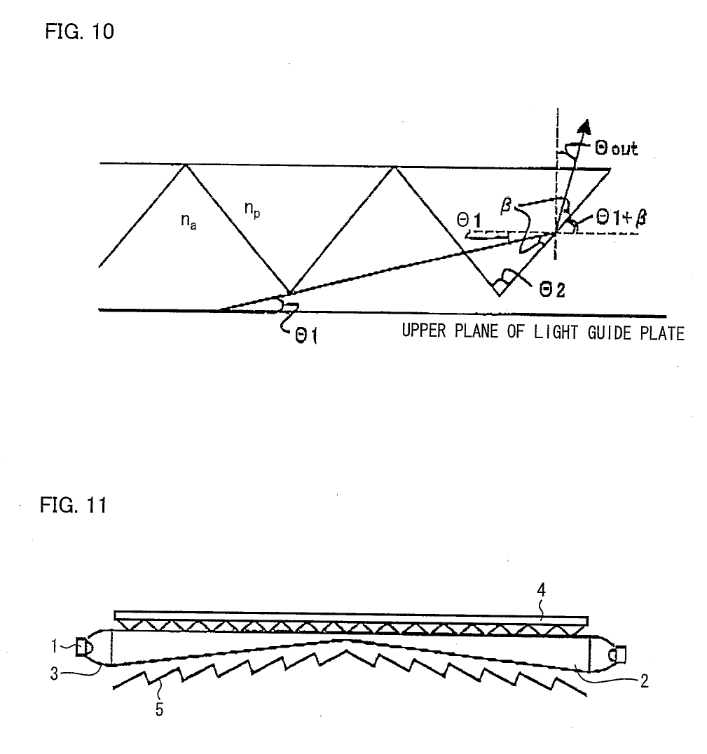

The following details a theory for obtaining the equation (1), with reference to FIG. 10.

In FIG. 10, nₐ represents a refractive index of air, nₚ represents a refractive index of a prism sheet, θₒᵤₜ represents an angle between a direction in which the first light is emitted from the prism sheet and the vertical upper direction, β represents an angle between a direction in which light (first light) is emitted from the upper plane of the light guide plate and a light reflecting plane of the prism sheet, θ₁ represents an angle between the upper plane of the light guide plate and a direction in which light (first light) is emitted from the upper plane of the light guide plate, and θ₂ represents an apex angle of the prism sheet.

When nₐ≈nₚ, the following approximation is met.

$$β = 90 ° - ( {θ}_{2} ) / 2 - {θ}_{1}$$

$$\begin{matrix}{θ}_{out} = 90 ° - 2 β - {θ}_{1} \\ = 90 ° - 2 \times ( 90 ° - ( {θ}_{2} ) / 2 - {θ}_{1} ) - {θ}_{1} \\ = 90 ° - ( 180 ° - {θ}_{2} - 2 {θ}_{1} ) - {θ}_{1} \\ = 90 ° - ( 180 ° - {θ}_{2} - 2 {θ}_{1} ) - {θ}_{1} \\ = {θ}_{2} + {θ}_{1} - 90 °\end{matrix}$$

$${θ}_{out} = \pm 10 °$$

Therefore,

θ₂=90°−θ₁±10°

The reason why θₒᵤₜ is within ±10° in case where the equation (1) is met is that the equation (1) is obtained under the condition that θₒᵤₜ=±10°.

The above calculations are based on the assumption that the refractive index of air nₐ is equal to the refractive index of a prism sheet nₚ. Almost similar result is obtained when actual refractive indices are used.

Consequently, as shown in FIG. 3 for example, the first light 10 is incident to the prism sheet 4, totally reflected in the prisms and is emitted from the upper plane of the prism sheet 4 with an emission angle θₒᵤₜ of ±10° or less with respect to a vertical upper direction, so that the first light 10 is emitted in a substantially vertical upper direction. This enables effectively reducing stray light.

It is preferable to design the prism sheet 4 such that the width W₁ of each prism (see FIG. 3) is 300 μm or less. When W₁ is more than 300 μm, spatial unevenness in luminance is more likely to be seen, which is undesirable. W₁ is preferably 100 μm or less, and more preferably 50 μm or less. Further, it is preferable that the area of a plane of the prism sheet 4 which plane faces the upper plane of the light guide plate 2 (the whole area of a plurality of prism surfaces) is not less than the area of the upper plane of the light guide plate 2. When the whole area of the plurality of prism surfaces is less than the area of the upper plane of the light guide plate 2, a ratio of light which is emitted from the upper plane of the light guide plate 2 but is not incident to the prism sheet 4 to light which is emitted from the upper plane of the light guide plate 2 and is incident to the prism sheet 4 increases, resulting in a lower utilization ratio of light.

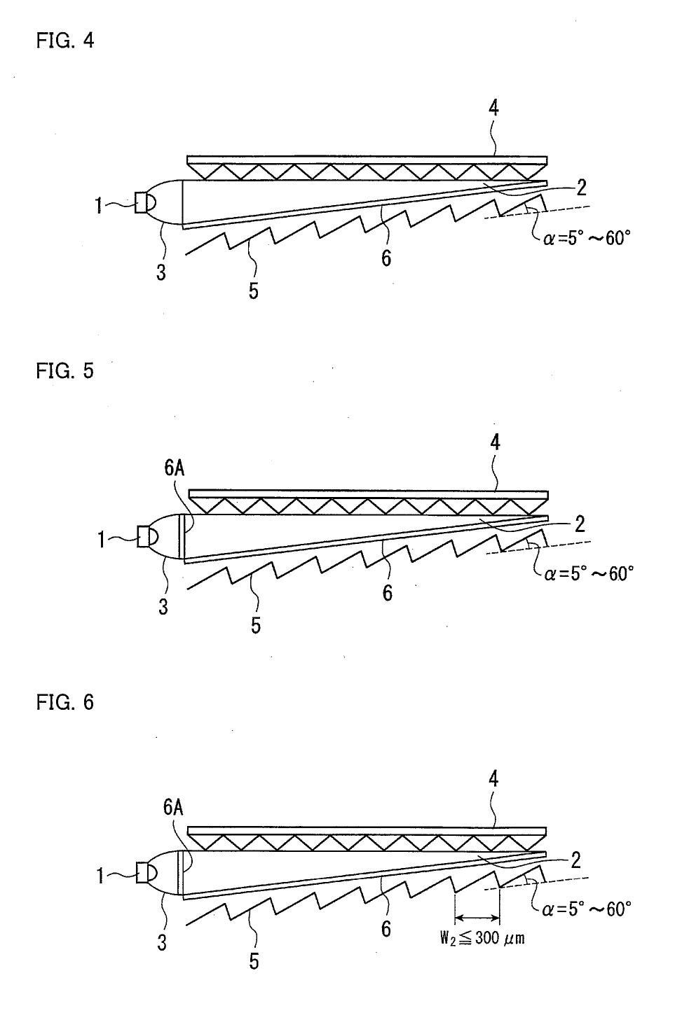

In the present invention, it is preferable to provide the lower plane of the light guide plate 2 with a reflection preventing film 6 as shown in FIG. 4 for example. Providing the lower plane of the light guide plate 2 with the reflection preventing film 6 enables reducing wasteful light which is emitted from the lower plane of the light guide plate 2 and reflected by the lower side reflector 5 but reflected by the lower plane of the light guide plate 2, thereby further increasing a utilization ratio of light.

The reflection preventing film 6 is used for preventing light which is emitted from the lower plane of the light guide plate 2 and is reflected by the lower side reflector 5 from being reflected by the lower plane of the light guide plate 2. The reflection preventing film 6 may be made of MgF₂, SiO₂, Sb₂O₅, TiO₂ etc for example.

Further, in the present invention, it is more preferable to provide the light-incident plane of the light guide plate 2 with a reflection preventing film 6A, as shown in FIG. 5 for example. Providing the light-incident plane of the light guide plate 2 with the reflection preventing film 6A enables reducing wasteful light which is emitted from the light source 1 but reflected by the light-incident plane of the light guide plate 2 and absorbed by the light source 1, thereby further increasing a utilization ratio of light.

The reflection preventing film 6A is used for preventing light emitted from the light source 1 from being reflected by the light-incident plane of the light guide plate 2. The reflection preventing film 6A is made of components similar to those of the reflection preventing film 6.

Further, in the present invention, it is preferable to design the lower side reflector 5 such that the width W₂ of each small reflecting plane is 300 μm or less, as shown in FIG. 6 for example. When W₂ is more than 300 μm, spatial unevenness in luminance is more likely to be seen, which is undesirable. W₂ is preferably 100 μm or less, and more preferably 50 μm or less. Further, it is preferable that the area of a plane of the lower side reflector 5 which plane faces the lower plane of the light guide plate 2 (the whole area of a plurality of small reflecting planes) is not less than the area of the lower plane of the light guide plate 2. When the whole area of the plurality of small reflecting planes is less than the area of the lower plane of the light guide plate 2, a ratio of light which is emitted from the lower plane of the light guide plate 2 but is not incident to the lower side reflector 5 to light which is emitted from the lower plane of the light guide plate 2 and is incident to the lower side reflector 5 increases, resulting in a lower utilization ratio of light.

As shown in FIG. 11, the planar light source device of the present invention may be arranged such that both ends of a light guide plate in a plate-length direction serve as light-incident planes of the light guide plate. Also in this embodiment, the planar light source device of the present invention mainly includes a light source 1, a light guide plate 2, a light source side reflector 3, a prism sheet (optical member) 4, and a lower side reflector (reflecting member) 5. Individual components of the planar light source device in this embodiment are the same as those of the planar light source device in which one end of a light guide plate in a plate-length direction serves as a light-incident plane of the light guide plate as shown in FIG. 1, an explanation thereof is omitted here.

### Examples

The following shows the result of concretely verifying the effect of the present invention with reference to an Example and a Comparative Example. It should be noted that the present invention is not limited to the Example below.

As the Example of the present invention, a planar light source device having the embodiment shown in FIG. 1 was manufactured by way of trial, and the point light source 1 made of an LED was turned on to emit luminous flux from the upper plane of the prism sheet 4, and the luminous flux was measured with a total luminous flux measurement system (produced by OTSUKA ELECTRONICS CO., LTD. LE-5100). Further, distribution of light emitted from the upper plane of the prism sheet 4 was measured with a diffusion angle characteristic measurement device (produced by Autronic. Conoscope).

The light source side reflector 3 had a reflector structure. The light source side reflector 3 surrounded the light source 1 and the light-incident plane of the light guide plate 2, with the inner surface of the light side reflector 3 serving as a reflecting surface.

The light guide plate 2 was made of polymethyl methacrylate (PMMA) (refractive index=1.4835). The light guide plate 2 was designed such that light from the light source 1 was introduced into the light guide plate 2 via the light-incident plane of the light guide plate 2 and was emitted from almost all the area of the light emission plane of the light guide plate 2.

The prism sheet 4 used here was designed such that the apex angle was approximately 60°, the width of each prism was approximately 50 μm, and the size of the prism sheet 4 (the whole area of a plurality of prism planes of the prism sheet 4) was larger than the upper plane of the light guide plate 2 (area of the upper plane of the light guide plate 2).

The lower side reflector 5 was obtained by evaporating a thin film of aluminum on planes of a member made of polymethyl methacrylate (PMMA) (refractive index=1.4835) so that the planes serve as small reflecting planes. The size of the lower side reflector 5 (the whole area of a plurality of small reflecting planes of the lower side reflector 5) was larger than the lower plane of the light guide plate 2 (area of the lower plane of the light guide plate 2). The shape of the reflecting plane of the lower side reflector 5 was designed such that a was approximately 38° and the width of each small reflecting plane was approximately 100 μm.

On the other hand, as the Comparative Example, a planar light source device was manufactured by way of trial in such a manner that the structure thereof was the same as that of the Example 1 except that the shape of the plane of the lower side reflector 5 was changed from the repetition of small reflecting planes to the planar shape of the large reflecting plane, and the lower side reflector 5 having the planar shape was positioned to be parallel to the lower plane of the light guide plate 2. Using this planar light source device, luminous flux and distribution of light were measured in the same manner as in the Example of the present invention.

As a result, luminous flux measured in the Example of the present invention was larger by approximately 3% than luminous flux measured in the Comparative Example. Further, distribution of light measured in the Example of the present invention was equal to or broader than distribution of light measured in the Comparative Example. It was confirmed from the comparison of the Example and the Comparative Example that the present invention yields an effect that light is obtained efficiently and the obtained light has a certain degree of angle distribution.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to a planar light source device used as a backlight etc. for a liquid crystal display device, and to a liquid crystal display device including the planar light source device.

### REFERENCE SIGNS LIST

1. Light source (e.g. point light source)
2. Light guide plate (wedge light guide plate whose cross section has wedge shape)
3. Light source side reflector
4. Prism sheet (optical member)
5. Lower side reflector (reflecting member)
6, 6A. Reflection preventing film
10. First light (light incident to light guide plate via light-incident plane of the light guide plate, passes through the light guide plate, and emitted from upper plane of the light guide plate)
11. Second light (light incident to light guide plate via light-incident plane of the light guide plate, passes through the light guide plate, emitted from the lower plane of the light guide plate, reflected by the lower side reflector, incident to the light guide plate again via the lower plane of the light guide plate, passes through the light guide plate, and is emitted from the upper plane of the light guide plate).

1. A planar light source device, comprising:
a light source;
a light guide plate including a light-incident plane via which light emitted from the light source is introduced into the light guide plate, and an upper plane and a lower plane serving as a pair of light emitting planes via which the introduced light is emitted from the light guide plate; and
a light source side reflector for reflecting light which is emitted from the light source and is not directly introduced into the light guide plate via the light-incident plane in such a manner that the reflected light is directed toward the light-incident plane,
the planar light source device further comprising:
a reflecting member, positioned to face the lower plane of the light guide plate, for reflecting light emitted from the lower plane of the light guide plate in such a manner that the reflected light is introduced into the light guide plate again; and
an optical member, positioned to face the upper plane of the light guide plate, for changing a traveling direction of light emitted from the upper plane of the light guide plate to a direction forming an angle of 10° or less with respect to an outward normal to the upper plane of the light guide plate,
a plurality of reflectors being positioned on the reflecting member, each of the plurality of reflectors standing at a position close to the light source in such a manner that an angle between each of the plurality of reflectors and the lower plane of the light guide plate is 5°-60°, and
the optical member being positioned in such a manner that an apex thereof faces the upper plane of the light guide plate and an equation (1) below is satisfied
θ₂=90°−θ₁±10° (1)
where θ₁ (°) represents a maximum angle between the upper plane and a direction in which the light is emitted from the upper plane and θ₂ (°) represents an angle of the apex.

2. A planar light source device, comprising:
at least one light source;
a light guide plate designed such that at least one end in a plate-length direction is a light-incident plane of the light guide plate, one of two ends in a plate-thickness direction is an upper plane of the light guide plate, the other is a lower plane of the light guide plate, the upper plane and the lower plane serve as light emitting planes, an outward normal to the upper plane of the light guide plate is a vertical upper direction, and light emitted from the light source is introduced into the light guide plate via the light-incident plane and is emitted from almost all areas of the light emitting planes; and
a light source side reflector for reflecting light emitted from the light source and light which is emitted from the light source and is reflected by the light-incident plane in such a manner that the light reflected by the light source side reflector is directed toward the light-incident plane,
the planar light source device further comprising:
a lower side reflector for reflecting light emitted from the lower plane of the light guide plate in such a manner that the reflected light is incident into the light guide plate again; and
an optical member for changing a traveling direction of first light to a substantially vertical upper direction, the first light being light which is introduced into the light guide plate via the light-incident plane, passes through the light guide plate, and is emitted from the upper plane of the light guide plate,
the lower side reflector being positioned to face the lower plane of the light guide plate, a plurality of small reflecting planes being positioned on the lower side reflector, and each of the plurality of small reflecting planes being inclined by an angle of 5°-60° with respect to the lower plane of the light guide plate in such a manner that a portion of each of the plurality of small reflecting planes which portion is farer from the light-incident plane of the light guide plate is closer to the lower plane of the light guide plate,
the optical member having an apex facing the upper plane of the light guide plate, and
an equation (1) below being satisfied
θ₂=90°−θ₁±10° (1)
where θ₁ (°) represents a maximum angle between the upper plane and a direction in which the first light is emitted from the upper plane and θ₂ (°) represents an angle of the apex.

3. The planar light source device as set forth in claim 1, wherein the optical member changes a traveling direction of second light to a direction inclined by more than 0° and not more than 60° with respect to a vertical upper direction, the second light being light which is introduced into the light guide plate via the light-incident plane, passes through the light guide plate, is emitted from the lower plane of the light guide plate, is reflected by the lower side reflector, is introduced into the light guide plate again via the lower plane of the light guide plate, passes through the light guide plate, and is emitted from the upper plane of the light guide plate.

4. The planar light source device as set forth in claim 1, wherein the lower side reflector is inclined by 20°-50° with respect to the lower plane of the light guide plane.

5. The planar light source device as set forth in claim 1, wherein the optical member is a prism sheet.

6. The planar light source device as set forth in claim 5, wherein the prism sheet is designed such that a width of each prism is 300 μm or less and an area of a plane of the prism sheet which plane faces the upper plane of the light guide plate is equal to or larger than an area of the upper plane of the light guide plate.

7. The planar light source device as set forth in claim 1, further comprising a reflection preventing film on the lower plane of the light guide plate.

8. The planar light source device as set forth in claim 7, further comprising a reflection preventing film on the light-incident plane of the light guide plate.

9. The planar light source device as set forth in claim 1, wherein the lower reflector is designed such that a width of each small reflecting plane is 300 μm or less and an area of a plane of the lower reflector which plane faces the lower plane of the light guide plate is equal to or larger than an area of the lower plane of the light guide plate.

10. The planar light source device as set forth in claim 2, wherein the optical member changes a traveling direction of second light to a direction inclined by more than 0° and not more than 60° with respect to a vertical upper direction, the second light being light which is introduced into the light guide plate via the light-incident plane, passes through the light guide plate, is emitted from the lower plane of the light guide plate, is reflected by the lower side reflector, is introduced into the light guide plate again via the lower plane of the light guide plate, passes through the light guide plate, and is emitted from the upper plane of the light guide plate.

11. The planar light source device as set forth in claim 2, wherein the lower side reflector is inclined by 20°-50° with respect to the lower plane of the light guide plane.

12. The planar light source device as set forth in claim 2, wherein the optical member is a prism sheet.

13. The planar light source device as set forth in claim 12, wherein the prism sheet is designed such that a width of each prism is 300 μm or less and an area of a plane of the prism sheet which plane faces the upper plane of the light guide plate is equal to or larger than an area of the upper plane of the light guide plate.

14. The planar light source device as set forth in claim 2, further comprising a reflection preventing film on the lower plane of the light guide plate.

15. The planar light source device as set forth in claim 14, further comprising a reflection preventing film on the light-incident plane of the light guide plate.

16. The planar light source device as set forth in claim 2, wherein the lower reflector is designed such that a width of each small reflecting plane is 300 μm or less and an area of a plane of the lower reflector which plane faces the lower plane of the light guide plate is equal to or larger than an area of the lower plane of the light guide plate.
